(19) United States
(12) Patent Application Publication
(10) Pub. No.: US 2024/0176793 A1
(43) Pub. Date: May 30, 2024

(54) FETCHING IDEAL DATA SETS BASED ON USAGE PATTERNS

(71) Applicant: SIGMA COMPUTING, INC., SAN FRANCISCO, CA (US)

(72) Inventor: DMITRI BRONNIKOV, FOSTER CITY, CA (US)

(21) Appl. No.: 18/164,134

(22) Filed: Feb. 3, 2023

Related U.S. Application Data
(63) Continuation-in-part of application No. 17/529,748, filed on Nov. 18, 2021.

(51) Int. Cl. G06F 16/25; G06F 16/2455; G06F 16/28

(52) U.S. Cl. CPC G06F 16/254; G06F 16/2455; G06F 16/283

(57) ABSTRACT

Systems and methods of fetching ideal data sets based on usage patterns are disclosed. The systems and methods include receiving a state specification of a graphical user interface, the state specification corresponding to a database query composed to retrieve, from a cloud-based data warehouse, a first data set associated with a workbook; identifying, for the workbook, a previous usage pattern representing a set of interactions with the workbook on a client computing device; determining, based on the identified previous usage pattern, a set of database queries that is anticipated to be executed by the client computing device, wherein the set of database queries corresponds to a second data set; and fetching, from the cloud-based data warehouse, a one or more execution results that include the first data set and the second data set.

### BACKGROUND

### Field of the Invention

The field of the invention is data processing, or, more specifically, methods, apparatus, and products for prefetching query results using expanded queries.

### Description of Related Art

Modern businesses may store large amounts of data in remote databases within cloud-based data warehouses. This data may be accessed using database query languages, such as structured query language (SQL). Manipulating the data stored in the database may require constructing complex queries beyond the abilities of most users. Further, composing and issuing database queries efficiently may also be beyond the abilities of most users.

### SUMMARY

Methods, systems, and apparatus for fetching ideal data sets based on usage patterns including receiving a state specification of a graphical user interface, the state specification corresponding to a database query composed to retrieve, from a cloud-based data warehouse, a first data set associated with a workbook; identifying, for the workbook, a previous usage pattern representing a set of interactions with the workbook on a client computing device, wherein the previous usage pattern includes the database query; based on the identified previous usage pattern, determining a set of database queries that is anticipated to be executed by the client computing device, wherein the set of database queries corresponds to a second data set; and fetching, from the cloud-based data warehouse, one or more execution results that include the first data set and the second data set.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for prefetching query results using expanded queries according to embodiments of the present invention.

FIG. 2 sets forth a block diagram of an example system configured for prefetching query results using expanded queries according to embodiments of the present invention.

FIG. 3 sets forth a block diagram of an example system configured for prefetching query results using expanded queries according to embodiments of the present invention.

FIG. 4 sets forth a flow chart illustrating an exemplary method for prefetching query results using expanded queries according to embodiments of the present invention.

FIG. 5 sets forth a flow chart illustrating an exemplary method for prefetching query results using expanded queries according to embodiments of the present invention.

FIG. 6 sets forth a flow chart illustrating an exemplary method for prefetching query results using expanded queries according to embodiments of the present invention.

FIG. 7 sets forth a flow chart illustrating an exemplary method for fetching ideal data sets based on usage patterns according to embodiments of the present invention.

FIG. 8 sets forth a flow chart illustrating an exemplary method for fetching ideal data sets based on usage patterns according to embodiments of the present invention.

FIG. 9 sets forth a flow chart illustrating an exemplary method for fetching ideal data sets based on usage patterns according to embodiments of the present invention.

FIG. 10 sets forth a flow chart illustrating an exemplary method for fetching ideal data sets based on usage patterns according to embodiments of the present invention.

FIG. 11 sets forth a flow chart illustrating an exemplary method for fetching ideal data sets based on usage patterns according to embodiments of the present invention.

FIG. 12 sets forth a flow chart illustrating an exemplary method for fetching ideal data sets based on usage patterns according to embodiments of the present invention.

### DETAILED DESCRIPTION

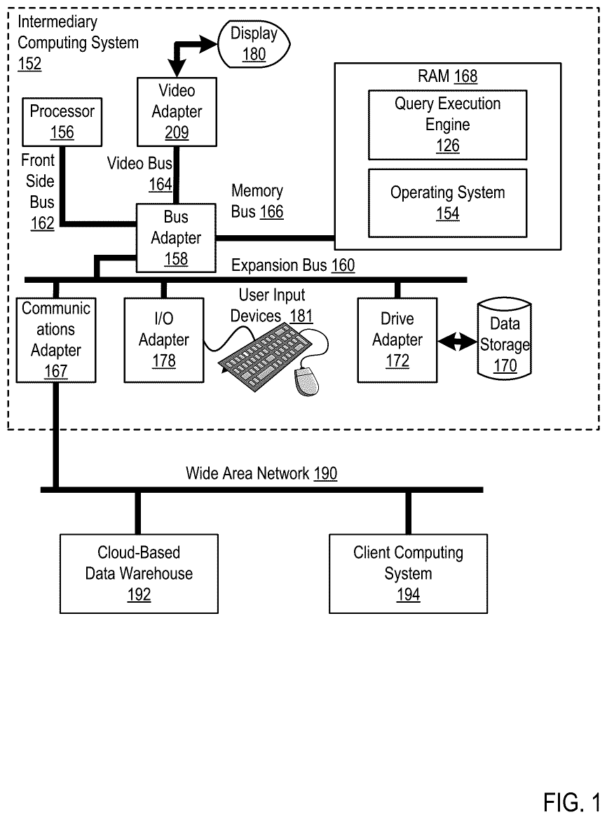

Exemplary methods, apparatus, and products for fetching ideal data sets based on usage patterns in accordance with the present invention are described with reference to the accompanying drawings, beginning with FIG. 1. FIG. 1 sets forth a block diagram of automated computing machinery comprising an exemplary intermediary computing system 152 configured for prefetching query results using expanded queries according to embodiments of the present invention. The intermediary computing system 152 of FIG. 1 includes at least one computer processor 156 or ‘CPU’ as well as random access memory 168 (‘RAM’) which is connected through a high speed memory bus 166 and bus adapter 158 to processor 156 and to other components of the intermediary computing system 152.

Stored in RAM 168 is an operating system 154. Operating systems useful in computers configured for prefetching query results using expanded queries according to embodiments of the present invention include UNIX™, Linux™, Microsoft Windows™, AIX™, and others as will occur to those of skill in the art. The operating system 154 in the example of FIG. 1 is shown in RAM 168, but many components of such software typically are stored in non-volatile memory also, such as, for example, on data storage 170, such as a disk drive. Also stored in RAM is the query execution engine 126, a module for prefetching query results using expanded queries according to embodiments of the present invention.

The intermediary computing system 152 of FIG. 1 includes disk drive adapter 172 coupled through expansion bus 160 and bus adapter 158 to processor 156 and other components of the intermediary computing system 152. Disk drive adapter 172 connects non-volatile data storage to the intermediary computing system 152 in the form of data storage 170. Disk drive adapters useful in computers configured for prefetching query results using expanded queries according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example intermediary computing system 152 of FIG. 1 includes one or more input/output (′I/O′) adapters 178. I/O adapters implement user-oriented input/output through, for example, software drivers and computer hardware for controlling output to display devices such as computer display screens, as well as user input from user input devices 181 such as keyboards and mice. The example intermediary computing system 152 of FIG. 1 includes a video adapter 209, which is an example of an I/O adapter specially designed for graphic output to a display device 180 such as a display screen or computer monitor. Video adapter 209 is connected to processor 156 through a high speed video bus 164, bus adapter 158, and the front side bus 162, which is also a high speed bus.

The exemplary intermediary computing system 152 of FIG. 1 includes a communications adapter 167 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for prefetching query results using expanded queries according to embodiments of the present invention include modems for wired dial-up communications, Ethernet (IEEE 802.3) adapters for wired data communications, and 802.11 adapters for wireless data communications.

The communications adapter 167 is communicatively coupled to a wide area network 190 that also includes a cloud-based data warehouse 192 and a client computing system 194. The cloud-based data warehouse 192 is a computing system or group of computing systems that hosts a database or databases for access over the wide area network 190. The client computing system 194 is a computing system that accesses the database using the query execution engine 126. Although FIG. 1 depicts the query execution engine within the intermediary computing system 152, the query execution engine may alternatively be executed within the client computing system 194.

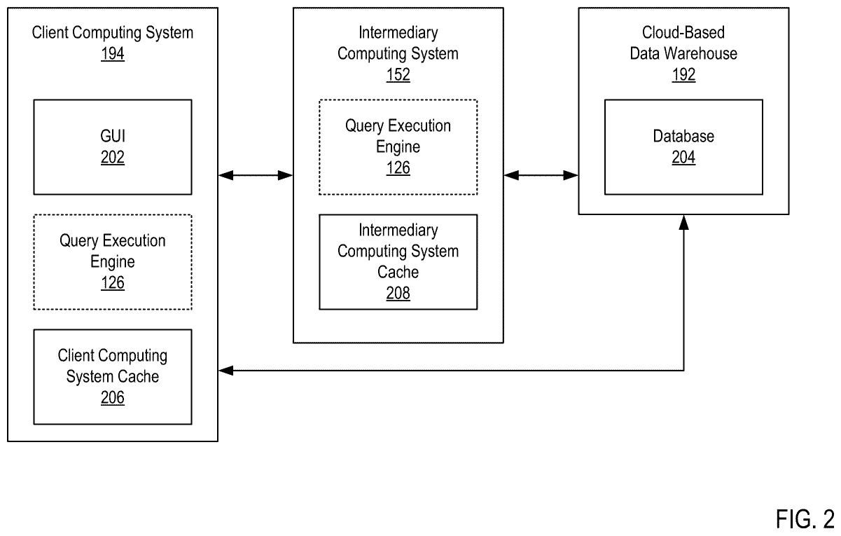

FIG. 2 shows an exemplary system for prefetching query results using expanded queries according to embodiments of the present invention. As shown in FIG. 2, the system includes a client computing system 194, an intermediary computing system 152, and a cloud-based data warehouse 192. The client computing system 194 includes a graphical user interface (GUI) 202 and a client computing system cache 206. The intermediary computing system 152 includes an intermediary computing system cache 208. The cloud-based data warehouse 192 includes a database 204. The query execution engine 126 may reside on either the client computing system 194 and/or the intermediary computing system 152 and utilize the associated computing system cache (client computing system cache 206, intermediary computing system cache 208). The cache may be a browser cache associated with an Internet browser. The client computing system 194 may access the cloud-based data warehouse 192 and database 204 directly or may access the cloud-based data warehouse 192 and database 204 via the intermediary computing system 152.

The GUI 202 is a visual presentation configured to present data sets in the form of worksheets and graphical elements to a user. The GUI 202 also receives requests from a user for data sets from the database 204. The GUI 202 may be presented, in part, by the query execution engine 126 and displayed on a client computing system 194 (e.g., on a system display or mobile touchscreen). The GUI 202 may be part of an Internet application that includes the query execution engine 126 and is hosted on the intermediary computing system 152. Alternatively, the GUI 202 may be part of an Internet application that includes the query execution engine 126 and is hosted on the client computing system 194.

The database 204 is a collection of data and a management system for the data. A data set is a collection of data (such as a table) from the database 204. Data sets may be organized into columns and rows (also referred to as records). The particular columns, rows, and organization of the columns and rows that make up a data set may be specified in the database statement requesting the data set. A data set, as sent from the database to the intermediary computing system 152 and client computing system 194, may be a portion or subset of a source database table on the database. Data sets may be sent from the cloud-based data warehouse 192 in response to a database query. Accordingly, data sets retrieved in response to a database query may be referred to as query results.

The query execution engine 126 is hardware, software, or an aggregation of hardware and software configured to receive a state specification from the client computing system 194, via the GUI 202. The query execution engine 126 is also configured to generate database queries in response to manipulations of the GUI 202 described in the state specification.

The state specification is a collection of data describing inputs into the GUI 202. The state specification may include manipulations of GUI elements within the GUI 202 along with data entered into the GUI 202 by a user of the client computing system 194. Such manipulations and data may indicate requests for and manipulations of data sets. The state specification may be a standard file format used to exchange data in asynchronous browser-server communication. For example, the state specification may be a JavaScript Object Notation specification.

The state specification may include descriptions of elements that are used to apply changes to the data set. Such elements may include filters applied to the worksheet, the hierarchical level of the worksheet, joins performed within the worksheet, exposable parameters in the worksheet, and security for the worksheet.

The query execution engine 126 uses the state specification as input to generate a database query. This transformation process may begin with state specification being converted into an abstract syntax tree. The abstract syntax tree may then be canonicalized into a canonicalized hierarchy. The canonicalized hierarchy may then be linearized into the worksheet algebra. The worksheet algebra may then be lowered into a relational algebra, which may then be lowered into the database query.

The query execution engine 126 may use the database query to fetch query results (i.e. a data set) from the database 204. The query execution engine 126 may then present the query results to a user via the GUI 202. The query execution engine 126 may also store the query results in a cache (client computing system cache 206, intermediary computing system cache 208) for later retrieval if the same or similar query is generated from a state specification. Further, as described below, the query execution engine 126 may expand the generated database queries such that the expanded results stored in the cache may be used to locally service a greater number of database queries without sending additional database queries to the cloud-based data warehouse 192.

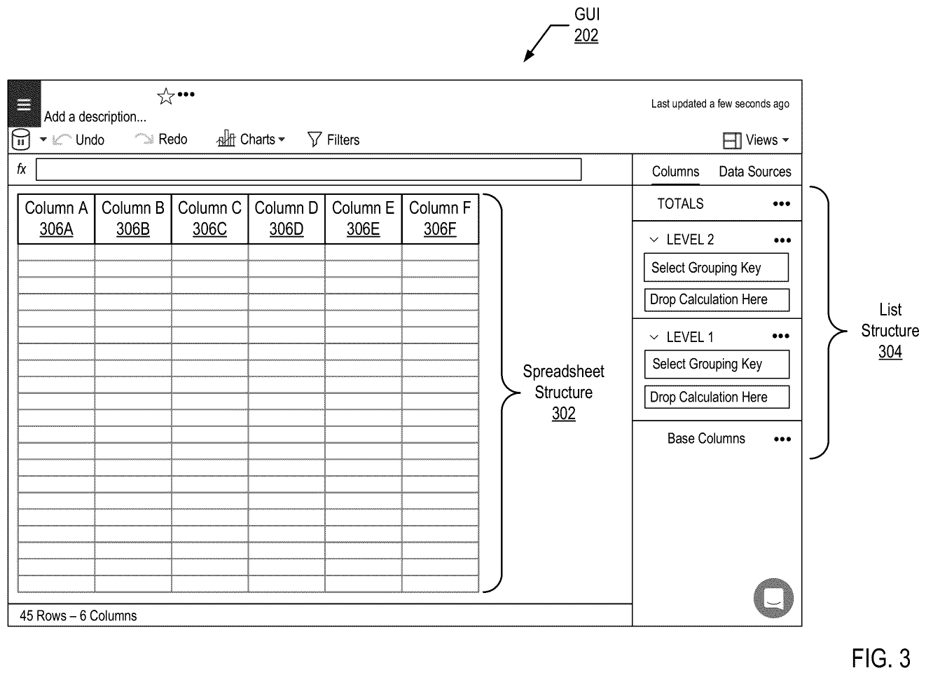

FIG. 3 shows an exemplary system for prefetching query results using expanded queries according to embodiments of the present invention. As shown in FIG. 3, the exemplary GUI 202 includes a spreadsheet structure 302 and a list structure 304. The spreadsheet structure 302 includes a worksheet (shown as empty rows) with six columns (column A 306A, column B 306B, column C 306C, column D 306D, column E 306E, column F 306F).

The spreadsheet structure 302 is a graphical element and organizing mechanism for a worksheet that presents a data set. A worksheet is a presentation of a data set (such as a table) from a database on a data warehouse. The spreadsheet structure 302 displays the worksheet as rows of data organized by columns (column A 306A, column B 306B, column C 306C, column D 306D, column E 306E, column F 306F). The columns delineate different categories of the data in each row of the worksheet. The columns may also be calculation columns that include calculation results using other columns in the worksheet.

The list structure 304 is a graphical element used to define and organize the hierarchical relationships between the columns (column A 306A, column B 306B, column C 306C, column D 306D, column E 306E, column F 306F) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure 304 presents a dimensional hierarchy to the user. Specifically, the list structure 304 presents levels arranged hierarchically across at least one dimension. Each level within the list structure 304 is a position within a hierarchical relationship between columns (column A 306A, column B 306B, column C 306C, column D 306D, column E 306E, column F 306F). The keys within the list structure 304 identify the one or more columns that are the participants in the hierarchical relationship. Each level may have more than one key.

One of the levels in the list structure 304 may be a base level. Columns selected for the base level provide data at the finest granularity. One of the levels in the list structure 304 may be a totals or root level. Columns selected for the totals level provide data at the highest granular level. For example, the totals level may include a field that calculates the sum of each row within a single column of the entire data set (i.e., not partitioned by any other column).

The GUI 202 may enable a user to drag and drop columns (column A 306A, column B 306B, column C 306C, column D 306D, column E 306E, column F 306F) into the list structure 304. The order of the list structure 304 may specify the hierarchy of the columns relative to one another. A user may be able to drag and drop the columns in the list structure 304 at any time to redefine the hierarchical relationship between columns. The hierarchical relationship defined using the columns selected as keys in the list structure 304 may be utilized in charts such that drilling down (e.g., double click on a bar), enables a new chart to be generated based on a level lower in the hierarchy.

The GUI 202 may also include a mechanism for a user to request a table from a database to be presented as a worksheet in the GUI 202. Such a mechanism may be part of the interactivity of the worksheet. Specifically, a user may manipulate a worksheet (e.g., by dragging and dropping columns or rows, resorting columns or rows, etc.) and, in response, the GUI 202 may generate a request (e.g., in the form of a state specification) for a data set and send the request to the query execution engine 126. Such a mechanism may also include a direct identification of the rows and columns of a database table that a user would like to access (e.g., via a selection of the rows and columns in a dialog box).

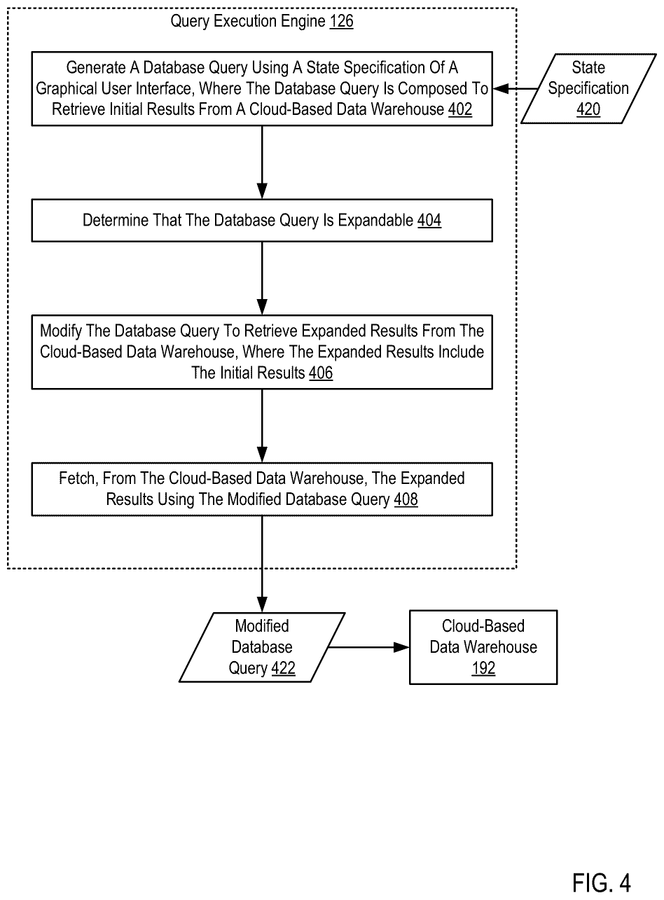

For further explanation, FIG. 4 sets forth a flow chart illustrating an exemplary method for prefetching query results using expanded queries according to embodiments of the present invention. As discussed above, the query execution engine 126 may reside with the GUI on a client computing system or separate from the GUI on the intermediary computing system between the client computing system and the cloud-based data warehouse 192. Alternatively, portions of the query execution engine 126 may be distributed between the client computing system and the intermediary computing system.

The method of FIG. 4 includes generating 402 a database query using a state specification 420 of a graphical user interface, wherein the database query is composed to retrieve initial results from a cloud-based data warehouse 192. Generating 402 a database query using a state specification 420 may be carried out by detecting that a user has manipulated elements of the GUI and/or submitted data using the GUI such that the generation of a state specification 420 is triggered, and the state specification 420 is sent to the query execution engine 126. For example, a user may select a table from a group of tables presented for display in a worksheet on the GUI. As another example, a user may change the order of columns in the dimensional hierarchy of the GUI. Each change to the GUI may result in a new or updated state specification 420.

The state specification 420 may then be translated into the database query. Specifically, the state specification is converted or lowered into various intermediate forms, including an abstract syntax tree, a canonicalized hierarchy, a worksheet algebra, and a relational algebra. During each of these intermediate forms, the query execution engine 126 may optimize the database query to efficiently retrieve the initial results from the database. The resulting database query may be a structured query language statement (SQL).

The method of FIG. 4 further includes determining 404 that the database query is expandable. Determining 404 that the database query is expandable may be carried out by evaluating the database query to determine whether the database query may be modified to retrieve expanded results. Specifically, before the database query is sent to the cloud-based data warehouse 192, the query execution engine 126 determines whether the database query includes attributes that indicate that the database query may be modified to retrieve a larger data set. Expanded results refers to a data set the includes the initial results targeted by the database query and, additionally, results not included in the initial results. The difference between the expanded results and initial results may be useful in servicing subsequent database queries.

Prior to determining whether the database query is expandable, the query execution engine 126 may search a local cache (client computing system cache or intermediary computing system cache) for a previously retrieved data set that includes the initial results. Previous query results may be stored in a cache (client computing system cache or intermediary computing system cache) local (i.e., on the same system) to the query execution engine 126. As each database query is generated, the cache may be searched in an attempt to service the database query using previously retrieved results. If a previously retrieved data set that includes the results of the current database query, then fetching the results from the cloud-based data warehouse 192 may be avoided.

The method of FIG. 4 further includes modifying 406 the database query to retrieve expanded results from the cloud-based data warehouse 192, wherein the expanded results include the initial results. Modifying 406 the database query to retrieve expanded results from the cloud-based data warehouse 192 may be carried out by altering one or more elements in the database query to cause the database query to retrieve additional results from the cloud-based data warehouse 192. Modifying 406 the database query may include adding or removing elements from the database query.

For example, the database query may be modified to remove or expand a filter applied to the initial results. Specifically, the generated database query may include a filter that excludes a portion of the data set that does not match the filter criteria. Removing or expanding the filter from the database query expands the results to include the data set that does not match the initial filter criteria.

As another example, the database query may be modified to expand the database query to retrieve additional columns. Specifically, the database query may be modified to include other columns from one or more of the tables targeted by the database query. Further, the query execution engine 126 may track the frequency of requests targeting specific columns of data. If the current database query includes columns from the same table without including the most frequently requested columns, the database query may be modified to include the frequently requested columns.

As another example, the database query may be modified to expand or remove limits within the database query. Specifically, the generated database query may include a limit that excludes rows of data beyond a specified boundary. Expanding or removing the limit from the database query expands the results to include further data beyond the specified boundary.

As another example, the database query may be modified to include data sets used by other elements within the GUI. For example, the GUI may include a graph along side the spreadsheet structure. The graph may require a first query result and the spreadsheet structure may present rows from a second query result. The database query may be modified to incorporate both the first query result and the second query result such that both the graph and the spreadsheet structure may be updated using the same database query.

The method of FIG. 4 further includes fetching 408, from the cloud-based data warehouse 192, the expanded results using the modified database query 422. Fetching 408, from the cloud-based data warehouse 192, the expanded results using the modified database query 422 may be carried out by sending, by the query execution engine 126, the modified database query 422 to a database on a cloud-based data warehouse 192. Upon receiving the modified database query 422, the database on the cloud-based data warehouse 192 may process the modified database query 422 to generate the result data set. Finally, the result data set is then transmitted back to the query execution engine 126 as the expanded results.

The above limitations improve the operation of the computer system by retrieving expanded results for a given database query thereby alleviating the need for subsequent calls to the cloud-base data warehouse for queries that target the expanded results. This is accomplished by determining whether a database query is expandable and modifying the database query to retrieve expanded results.

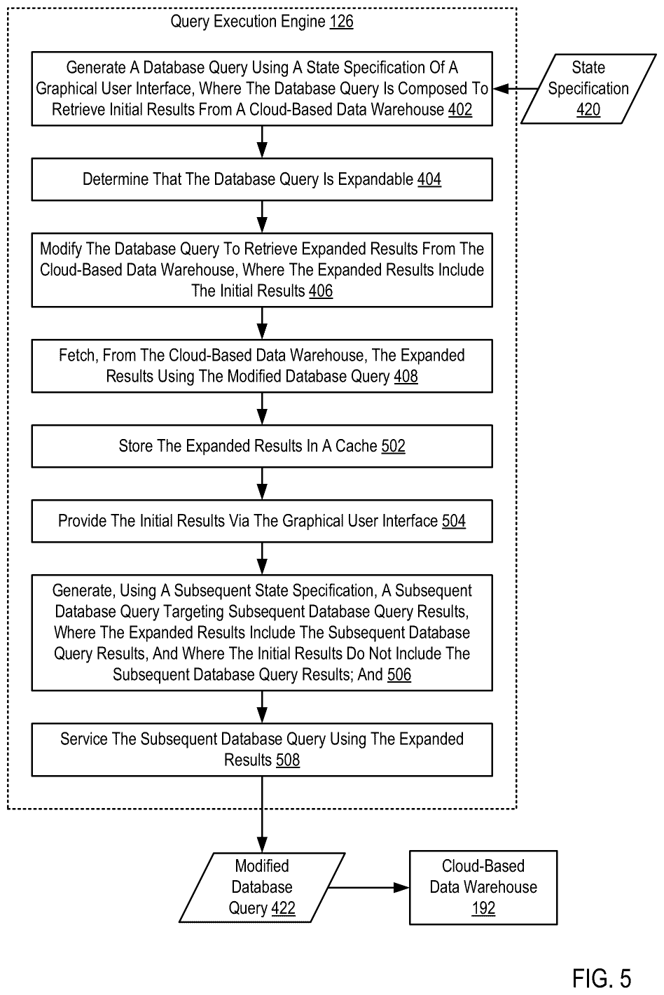

For further explanation, FIG. 5 sets forth a flow chart illustrating a further exemplary method for prefetching query results using expanded queries according to embodiments of the present invention that includes generating 402 a database query using a state specification 420 of a graphical user interface, wherein the database query is composed to retrieve initial results from a cloud-based data warehouse 192; determining 404 that the database query is expandable; modifying 406 the database query to retrieve expanded results from the cloud-based data warehouse 192, wherein the expanded results include the initial results; and fetching 408, from the cloud-based data warehouse 192, the expanded results using the modified database query 422.

The method of FIG. 5 differs from the method of FIG. 4, however, in that the method of FIG. 5 further includes storing 502 the expanded results in a cache. Storing 502 the expanded results in a cache may be carried out by loading the data set representing the expanded results into a location in the cache (client computing system cache or intermediary computing system cache) for the query execution engine 126. The cache location may be an area of memory allocated for use by the query execution engine 126 and may include results (including expanded results) from previous database queries.

The cache may be structured for searching by the query execution engine 126. Specifically, the results stored in the cache may be organized to provide efficient searching of previous results that match or include the results requested from the current database query. For example, the cache of results may be indexed by database query so that the current database query may be used as a key into the cache of results to determine whether results that include the results requested exist in the cache.

The method of FIG. 5 further includes providing 504 the initial results via the graphical user interface. Providing 504 the initial results via the graphical user interface may be carried out by first extracting the initial results from the expanded results. Once extracted, the initial results may be organized into the spreadsheet structure of the GUI on the client computing system. If the query execution engine 126 is executing within the client computing system, then the results are presented locally through the GUI. If the query execution engine 126 is executing within the intermediary computing system, then the results are transmitted to the client computing system before presentation through the GUI.

The method of FIG. 5 further includes generating 506, using a subsequent state specification, a subsequent database query targeting subsequent database query results, wherein the expanded results include the subsequent database query results, and wherein the initial results do not include the subsequent database query results. Generating 506 a subsequent database query using a subsequent state specification may be carried out by receiving the subsequent state specification from the GUI in response to subsequent inputs to the GUI. The subsequent state specification may be received at any point after the initial state specification used to retrieve the initial results. The subsequent database query results include data that was retrieved using the modified database query but would not have been included in the initial results.

The method of FIG. 5 further includes servicing 508 the subsequent database query using the expanded results. Servicing 508 the subsequent database query using the expanded results may be carried out by searching the cache for the subsequent database query results which may be keyed to a previous database query that matches at least part of the subsequent database query. Once the matching entry is found, the previous results may be retrieved from the cache and presented, via the GUI, as the subsequent database query results.

As an example of the above, assume that the query execution engine generates a database query to retrieve initial results “ABC”. The query execution engine may first determine whether “ABC” has been previously stored in the cache after a previously issue database query. If the initial results do not exist in the cache, the query execution engine may then determine that the database query is expandable and modifies the database query to retrieve expanded results “ABCD”. The query complier then retrieves “ABCD” from the cloud-based data warehouse and stores “ABCD” in the cache. At a later point, a subsequent database query is generated to retrieve “CD” from the cloud-based data warehouse. The query execution engine is able to retrieve “CD” from the cache without accessing the cloud-based data warehouse even though “D” was not previously requested via interactions with the GUI.

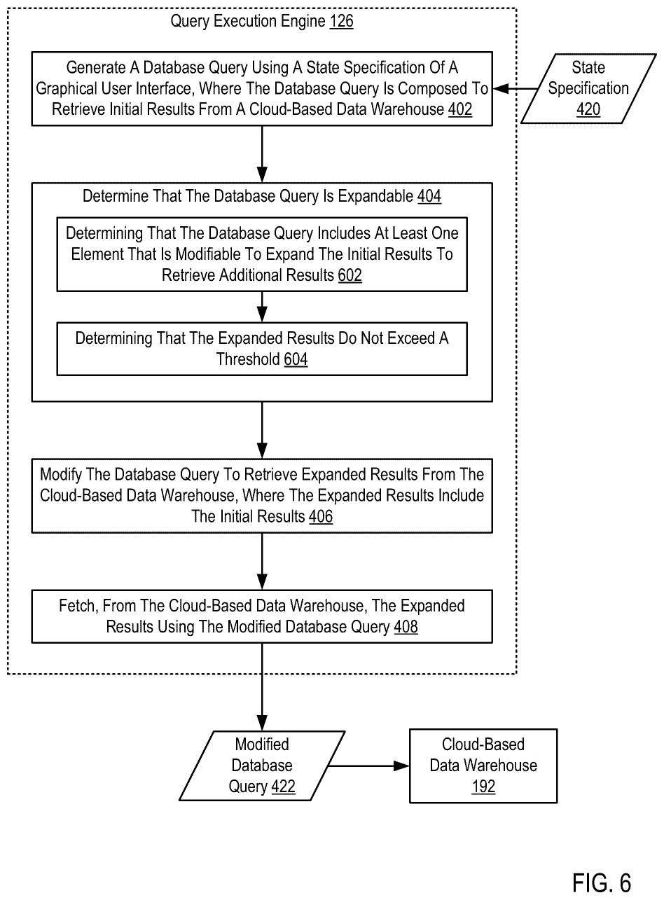

For further explanation, FIG. 6 sets forth a flow chart illustrating a further exemplary method for prefetching query results using expanded queries according to embodiments of the present invention that includes generating 402 a database query using a state specification 420 of a graphical user interface, wherein the database query is composed to retrieve initial results from a cloud-based data warehouse 192; determining 404 that the database query is expandable; modifying 406 the database query to retrieve expanded results from the cloud-based data warehouse 192, wherein the expanded results include the initial results; and fetching 408, from the cloud-based data warehouse 192, the expanded results using the modified database query 422.

The method of FIG. 6 differs from the method of FIG. 4, however, in that determining 404 that the database query is expandable includes determining 602 that the database query includes at least one element that is modifiable to expand the initial results to retrieve additional results and determining 604 that the expanded results do not exceed a threshold. Determining 602 that the database query includes at least one element that is modifiable to expand the initial results to retrieve additional results may be carried out by evaluating the elements within the database query to match one or more elements to elements that are modifiable and whose modification would expand the initial results. Such elements may include modifiers within the database query, such as a statement that includes a filter or limit instruction.

Determining 604 that the expanded results do not exceed a threshold may be carried out by determining an expected number of results (i.e. number of rows and columns) and comparing the expected number of results to a predetermined threshold number of results. Determining an expected number of results may be carried out by evaluating, by the query execution engine, the state specification and intermediary forms to extrapolate an expected number of record results in the results data set.

The threshold may be based on a limit imposed by the cloud-based data warehouse. Specifically, the cloud-based data warehouse may return an error for database queries that request results larger than the threshold. The threshold may also be based on a cost threshold for retrieving data sets from the cloud-based data warehouse. Specifically, the cloud-based data warehouse may charge a fee for each database query serviced based on the size of the data set requested. The query execution engine may limit the expanded results such that no additional fee is incurred beyond the fee for servicing the initial query results.

The database query may be modified accounting for the threshold. For example, removing a filter or limit may expand the results beyond the threshold. Consequently, the filer or limit may be expanded only to the point that the expanded results remain within the threshold.

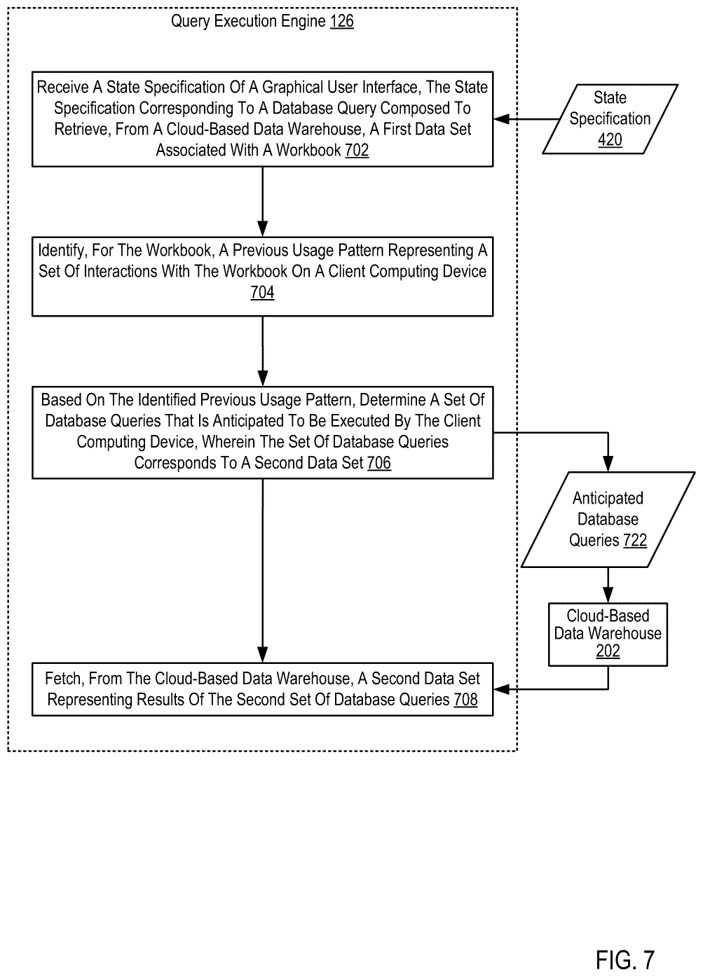

For further explanation, FIG. 7 sets forth a flow chart illustrating an exemplary method for fetching ideal data sets based on usage patterns according to embodiments of the present invention. Readers will appreciate that various methodologies or tools may exist that are configured to obtain additional data beyond that which is initially requested by a particular query. For example, there may be a query evaluation engine that evaluates a provided query to determine whether additional data should be fetched from a data store. However, such methods may be limited in their ability to obtain result data sets of queries that may be executed after an initial query. Such methods may be limited in that an insufficient amount of data may be retrieved as additional data, in that additional queries may not be able to be run using the retrieved data, without fetching even more data. Moreover, where an order of data retrieval is prescribed or required for proper presentation or usage of data, such known methods may lack the ability to properly retrieve data sets in the prescribed order. Furthermore, it may be difficult or cumbersome in known methods to properly delineate how much data is a sufficient amount of data to enable execution of additional queries that the user wishes to run beyond the initial query.

As described in FIGS. 7, 8, 9, 10, and 11, a workbook, like a worksheet, is a presentation of a data set (such as a table) from a database on a cloud-based data warehouse. A workbook may include one or more workbook elements. Each individual workbook element may present a data set from the cloud-based data warehouse. Further, each individual workbook element may present a data set in a different way. For example, one workbook element may present a data set as the spreadsheet structure in FIG. 3. Other examples include graphs, maps, and charts. The workbook organizes the data set from the cloud-based data warehouse into the workbook elements according to the workbook. The workbook may be a preexisting workbook created by a client using the client computing system 194 or may be a default workbook used after the data set is selected by the client. The workbook element may be a visualization or spreadsheet structure.

In general, different workbook elements may each represent different queries in that, for example, two workbook elements may be presented as a result of two different queries. Stated differently, different workbook elements may represent the results of different data sets that are retrieved, or fetched, as a result of different queries to a cloud-based data warehouse. Moreover, readers will appreciate that different workbook elements may be said to be ‘related’ to each other.

The method of FIG. 7 includes receiving 702 a state specification 420 of a graphical user interface, the state specification corresponding to a database query composed to retrieve, from a cloud-based data warehouse, a first data set associated with a workbook. As described above, a GUI may present a visual presentation configured to present data sets and workbooks to a client. Moreover, a workbook may include one or more workbook elements. Accordingly, receiving 702 a state specification 420 of a graphical user interface, the state specification corresponding to a database query composed to retrieve, from a cloud-based data warehouse, a first data set associated with a workbook can be carried out by receiving a collection of data describing inputs into the GUI that represents interactions with one or more workbook elements. Furthermore, all or part of a workbook element may correspond to a database query, such that interacting with the workbook element causes execution of a database query, resulting in retrieval of a result data set from, for example, cloud-based data warehouse 192. The result data set may, for example, be a snapshot of data associated with a workbook. In other words, the result data set may represent a snapshot in time of data associated with the workbook as it exists at a time of execution of the query. Readers will appreciate that receiving 702 the abovementioned state specification may represent interactions with a workbook element that cause execution of a database query which is composed to retrieve a first data set associated with the workbook.

The method of FIG. 7 also includes identifying 704, for the workbook, a previous usage pattern representing a set of interactions with the workbook on a client computing device, wherein the previous usage pattern includes the database query. Readers will appreciate that the interactions of a user or another application with a workbook may be patterned, sequential, ordered, or otherwise such that a particular pattern or sequence of events can be repeatably observed, detected, or predicted. As used herein, the term ‘usage pattern’ can refer to a particular set of interactions with a workbook that are associated with each other in a certain way (e.g., a sequence). Such usage patterns may include, for example, interaction with a first workbook element immediately before interaction with a second workbook element. The usage patterns may include specific types of interactions (e.g., that a graphical element, such as a button, is activated and then another graphical element, such as a dial, is adjusted in a specific manner). The usage patterns can include particular execution contexts, such as a particular time of day or day of the week. The usage patterns can include particular characteristics of a user or users, such as particular authorizations or permissions that are in us during interaction with the workbook. A particular usage pattern may include some or all of the abovementioned variants of usage patterns.

In one embodiment, identifying 704, for the workbook, a previous usage pattern representing a set of interactions with the workbook on a client computing device, wherein the previous usage pattern includes the database query can be carried out by evaluating prior interactions with workbook elements of the workbook. For example, identifying the usage pattern can include obtaining a history of query executions resulting from interactions with workbook elements. The obtained query execution history can then be analyzed to identify specific usage patterns. For example, as described above, a usage pattern can include that a first database query is executed prior to execution of a second database query. In other words, a first workbook element corresponding to the first database query is interacted with prior to interaction with a second workbook element that corresponds to the second database query. Given a threshold number of such interaction sequences of the first database query being executed prior to the second database query, it may be determined that the first database query and second database query are executed in a particular usage pattern for the workbook element. In one embodiment, the query execution history can include data or references to data that was retrieved from a database or added to a database as part of the execution of a query. In a related embodiment, the query execution history can include metadata of the abovementioned data or can include query execution metadata, such as query execution frequency, queried databases, metadata of cloud-based data warehouse 192, client computing system 194 and its sub-components, intermediary computing system 152 and its sub-components, or any other metadata about a particular query execution context.

As described above, identifying the usage pattern can involve ingesting query execution history and performing analysis or evaluation. In one embodiment, identifying the usage pattern can include inputting the query execution history into a machine learning model. In this example embodiment, the machine learning model may be configured to ingest the query execution history and output particular usage patterns for a workbook or set of workbook elements.

In one embodiment, the identified usage pattern can be associated with a workbook (e.g., a profile may be created for a workbook and stored in a workbook profile database where associations between workbooks and usage patterns are recorded). In another embodiment, the usage pattern can be associated with a workbook element, particular query, particular user, particular execution context. While the execution context has been described above in terms of execution timing (e.g., time of day or day of week), the execution context can encompass a plurality of factors that includes the timing and/or the particular user, or other contextual factors associated with query executions for a workbook.

In another embodiment, there may be interactions with the workbook that are part of a usage pattern but do not involve specific workbook elements. For example, initiating or opening the workbook could be part of a usage pattern. As another example, the workbook being active or open for a certain period of time may also be detectable as being part of a usage pattern for the workbook. Moreover, readers will appreciate that a usage pattern may be detected or may be determined to have occurred when a certain subset of the interactions associated with the usage pattern are detected. For example, a usage pattern may comprise three specific interactions in a particular order. However, if two of the three interactions occur, the query execution engine 126 may be configured to determine that the usage pattern has been detected.

The method of FIG. 7 also includes determining 706, based on the identified previous usage pattern, a set of database queries 722 that is anticipated to be executed by the client computing device, wherein the set of database queries corresponds to a second data set. Determining 706, based on the identified previous usage pattern, a set of database queries 722 that is anticipated to be executed by the client computing device, wherein the set of database queries corresponds to a second data set can be carried out in a variety of ways. For example, the first database query may be part of the usage pattern. The query execution engine 126 may be configured to determine, upon detection of the first database query, that a particular usage pattern involving the first database query is in effect such that that one or more other queries will be imminently executed. In response, the query execution engine 126 can identify these one or more other queries, or anticipated database queries. In one embodiment, the anticipated database queries represent other interactions that make up the abovementioned detected usage pattern. In another embodiment, the anticipated database queries may be separate from the identified usage pattern.

Readers will appreciate that various methods can be used to determine the set of anticipated database queries. For example, based on query execution history comprising 100 instances in which a workbook was used, it may be determined that after a query 1, a query 2 is executed in 95 instances, or 95% of the time, a query 3 is executed in 93 instances, or 93% of the time, and a query 4 is executed in 80 instances, or 80% of the time. The query execution engine 126 may be configured to determine the set of anticipated database queries based on a confidence level or other statistical measure. For example, query execution engine 126 may determine that any query whose execution occurs with a frequency of 90% or greater is an anticipated database query whose execution should be run if query 1 is observed to be executed. Based on the 90% cutoff, query 2 and 3 are determined to be an anticipated database query that is anticipated to be executed based on the execution of query 1. By contrast, query 4 is not considered to be an anticipated database query that is anticipated to be executed based on the execution of query 1. Readers will appreciate that the abovementioned cutoff for a query to qualify as an anticipated database query may be, for example, a user-configurable setting. As another example, the cutoff may be determined by use of a machine learning model, which ingests query execution history, identifies (or is provided) a particular proportion (e.g., 75%) of subsequent queries after a first query are executed, and determines a frequency with which each query in that particular proportion of queries is executed. The determined frequency may be, for example, 90%. This may indicate that 75% of the subsequent queries that have been observed after a particular first query are observed to executed 90% of the time. Accordingly, the query qualification cutoff mentioned above may be determined, based on the machine learning model, to be 90%. Any subsequent query that is executed less than 90% of the time after the initial query may be disqualified as an anticipated database query.

In another example embodiment, the identified usage pattern may not involve execution of the first query, or execution of any query. As noted above, the usage pattern may comprise other interactions associated with the workbook (e.g., opening the workbook, keeping the workbook open for a certain time). Based on these other interactions, query execution engine 126 may determine one or more anticipated database queries. For example, when a certain workbook is first opened, query execution engine 126 may determine, based on query execution history for that workbook, that an example query, query 5, is executed 95% of the time within one minute of workbook opening. Based on the abovementioned query execution history, query execution engine 126 may determine that when the workbook is first opened, the usage pattern is detected and, in response, query 5 may be determined to be an anticipated database query. In a related embodiment, the anticipated database queries may be child queries of a parent query, where the workbook elements operate using a workbook element hierarchy or query hierarchy that defines ‘parent’ and ‘child’ database queries.

The method of FIG. 7 also includes fetching 708, from the cloud-based data warehouse, one or more execution results that include the first data set and the second data set. Fetching 708, from the cloud-based data warehouse, one or more execution results that include the first data set and the second data set can be carried out by fetching a single data set that includes the execution results of the first database query (e.g., the first data set) as well as some or all of the anticipated database queries. In another embodiment, fetching 708, from the cloud-based data warehouse, one or more execution results that include the first data set and the second data set can be carried out by fetching both the first data set and a separate second data set that represents the execution results of one or more of the anticipated database queries, such as anticipated queries 722. Regardless of the structure of the returned data or data sets, the execution results of the first database query and the anticipated database queries can be stored at client computing system as a result of the fetching 708.

Readers will appreciate that while the structure or order of the data set(s) that are retrieved may vary, there may be a single query execution or single communication from query execution engine 126 to cloud-based data warehouse 192 that results in the retrieval of both the first data set and also a second data set (or plurality of data sets) that represent the execution results of the anticipated database queries. In other words, the receipt of the state specification corresponding to the first database query can result in a single retrieval from the cloud-based data warehouse 192 that comprises results of the first database query as well as results of the anticipated database queries. For example, the anticipated database queries may be automatically executed in response to receipt of the state specification for the first database query. Similarly, the detection of some portion of a usage pattern (e.g., execution of a database query or some interaction with the workbook that does not involve a workbook element or query execution) can result in automatic initiation of the remainder of the usage pattern (e.g., anticipated database queries), or execution of anticipated database queries that fall outside the observed usage pattern. The retrieved data may be a single data set or table. Alternatively, the retrieved data may be organized into multiple different data sets retrieved in a single retrieval or multiple retrievals.

Readers will appreciate that the abovementioned single retrieval of data can result in updated presentations of one or more workbook elements. For example, the query execution engine 126 may be configured to cause or update the presentation of a plurality of workbook elements in response to receiving the execution results that correspond to the first database query and the anticipated database queries. As a more specific example, a first data set may result from execution of the first database query, and the first data set may be presented using a first workbook element. However, the single retrieval of data may also return execution results of the one or more anticipated database queries. These execution results may cause presentation of (or updated presentation of) one or more other workbook elements that are different from the first workbook element. In other words, the receipt of the state specification for the first database query can cause presentation of data in workbook elements that are separate from the first workbook element that corresponds to the first database query. Moreover, the single retrieval of data can result in the retrieved data set or data sets being stored at the client computing system 194. The abovementioned presentation can include some or all of the stored data.

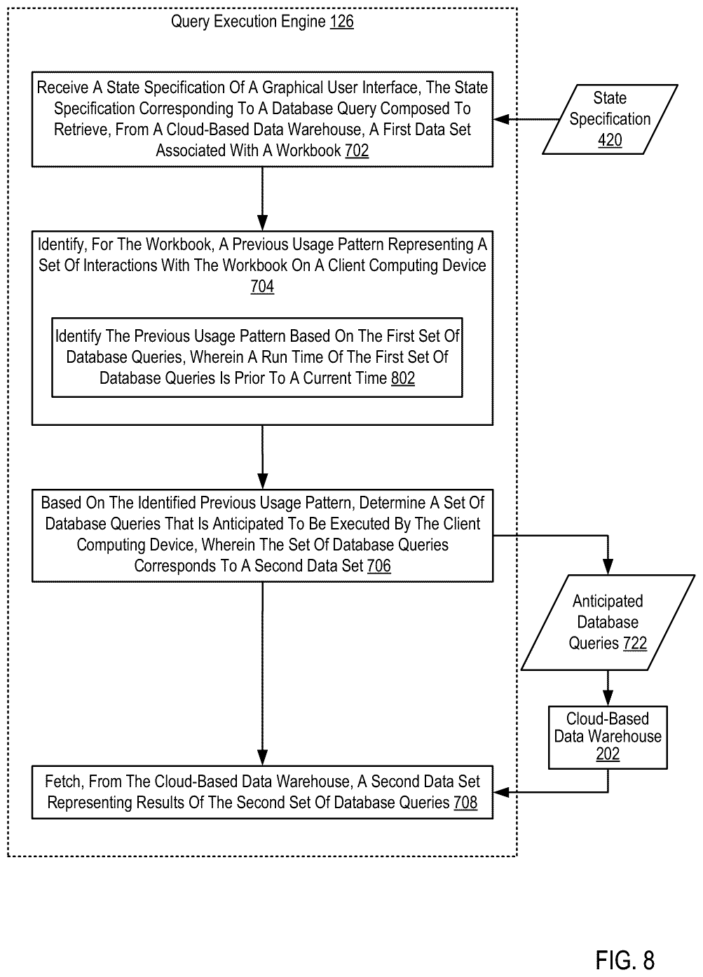

For further explanation, FIG. 8 sets forth a flow chart illustrating a further exemplary method for fetching ideal data sets based on usage patterns according to embodiments of the present invention. The method of FIG. 8 is similar to the method of FIG. 7 in that the method of FIG. 8 also includes receiving 702 a state specification of a graphical user interface, the state specification corresponding to a database query composed to retrieve, from a cloud-based data warehouse, a first data set associated with a workbook; identifying 704, for the workbook, a previous usage pattern representing a set of interactions with the workbook on a client computing device, wherein the previous usage pattern includes the database query; determining 706, based on the identified previous usage pattern, a set of database queries that is anticipated to be executed by the client computing device, wherein the set of database queries corresponds to a second data set; and fetching 708, from the cloud-based data warehouse, one or more execution results that include the first data set and the second data set.

The method of FIG. 8 differs from the method of FIG. 7, however, in that identifying 704, for the workbook, a previous usage pattern representing a set of interactions with the workbook on a client computing device, wherein the previous usage pattern includes the database query includes identifying 802 the previous usage pattern based on the database query, wherein a run time of the database query is prior to a current time. Identifying 802 the previous usage pattern based on the database query, wherein a run time of the database query is prior to a current time may be carried out as described above, where a state specification of the first database query is received prior to a current time. In response, query execution engine 126 may detect that the first database query is part of a usage pattern that includes one or more other database queries that are anticipated to be executed next. In response, query execution engine 126 can determine the anticipated database queries as described above and execute the anticipated database queries based on the immediately preceding execution of the first database query.

Identifying 802 the previous usage pattern based on the database query, wherein a run time of the database query is prior to a current time can also be carried out by evaluating prior executions of the first database query from an earlier time in the past. For example, as described above, the first database query may have been executed at an earlier time (e.g., one week ago) with respect to a particular workbook. Moreover, a set of subsequent queries may have been executed after the first database query with a frequency of execution that satisfies a threshold frequency. In response, query execution engine 126 may determine, based on the run time of the first database query prior to the current time, that a usage pattern exists involving the first database query.

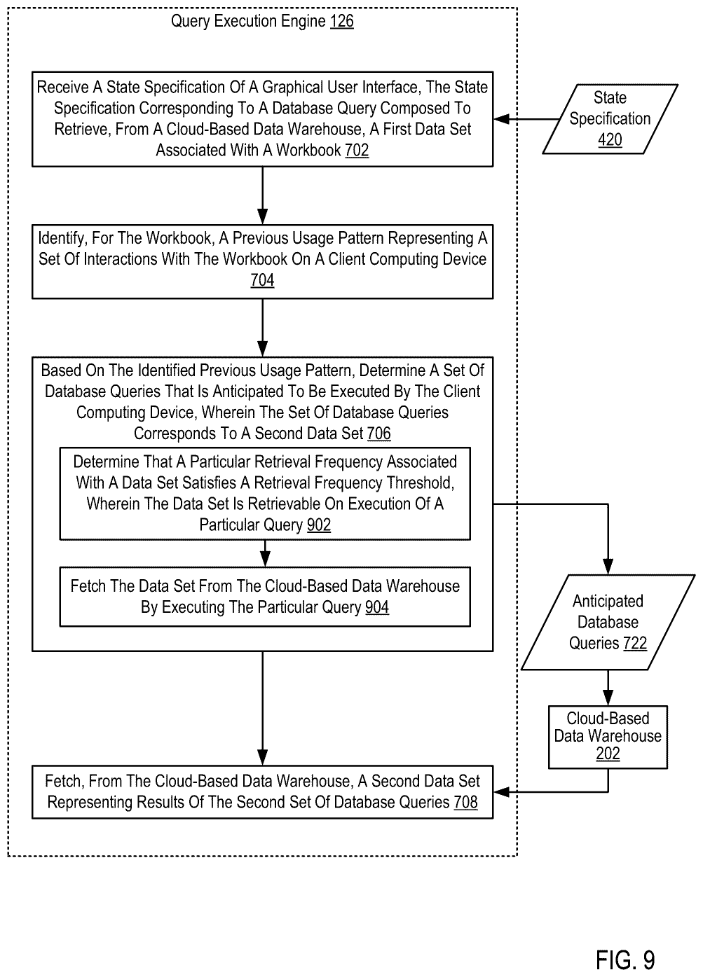

For further explanation, FIG. 9 sets forth a flow chart illustrating a further exemplary method for fetching ideal data sets based on usage patterns according to embodiments of the present invention. The method of FIG. 9 is similar to the method of FIG. 7 in that the method of FIG. 9 also includes receiving 702 a state specification of a graphical user interface, the state specification corresponding to a database query composed to retrieve, from a cloud-based data warehouse, a first data set associated with a workbook; identifying 704, for the workbook, a previous usage pattern representing a set of interactions with the workbook on a client computing device, wherein the previous usage pattern includes the database query; determining 706, based on the identified previous usage pattern, a set of database queries that is anticipated to be executed by the client computing device, wherein the set of database queries corresponds to a second data set; and fetching 708, from the cloud-based data warehouse, one or more execution results that include the first data set and the second data set.

The method of FIG. 9 differs from the method of FIG. 7, however, in that determining 706, based on the identified previous usage pattern, a set of database queries that is anticipated to be executed by the client computing device, wherein the set of database queries corresponds to a second data set includes determining 902 that a particular retrieval frequency associated with a data set satisfies a retrieval frequency threshold, wherein the data set is retrievable on execution of a particular query. As described above, a data set may have associated metadata, which may include a retrieval frequency for the data set. Determining 902 that a particular retrieval frequency associated with a data set satisfies a retrieval frequency threshold, wherein the data set is retrievable on execution of a particular query can be carried out by determining that a particular data set is retrieved as a result of the execution of an anticipated database query that is anticipated to be executed after a first database query, as described above. Retrieval of the particular data set may satisfy a retrieval frequency threshold in that the particular data set (e.g., results of execution of an anticipated database query) may be observed to be retrieved more than a threshold number of times after a first database query is run.

The method of FIG. 9 also includes fetching 904 the data set from the cloud-based data warehouse by executing the particular query. As described above, the particular query may be an anticipated database query with respect to the first database query for which a state specification of a graphical interface is received. Accordingly, fetching 904 the data set can include automatically executing the particular query, or anticipated database query, and retrieving the execution results. The retrieved execution results may be part of a single data set that also includes execution results of the first database query.

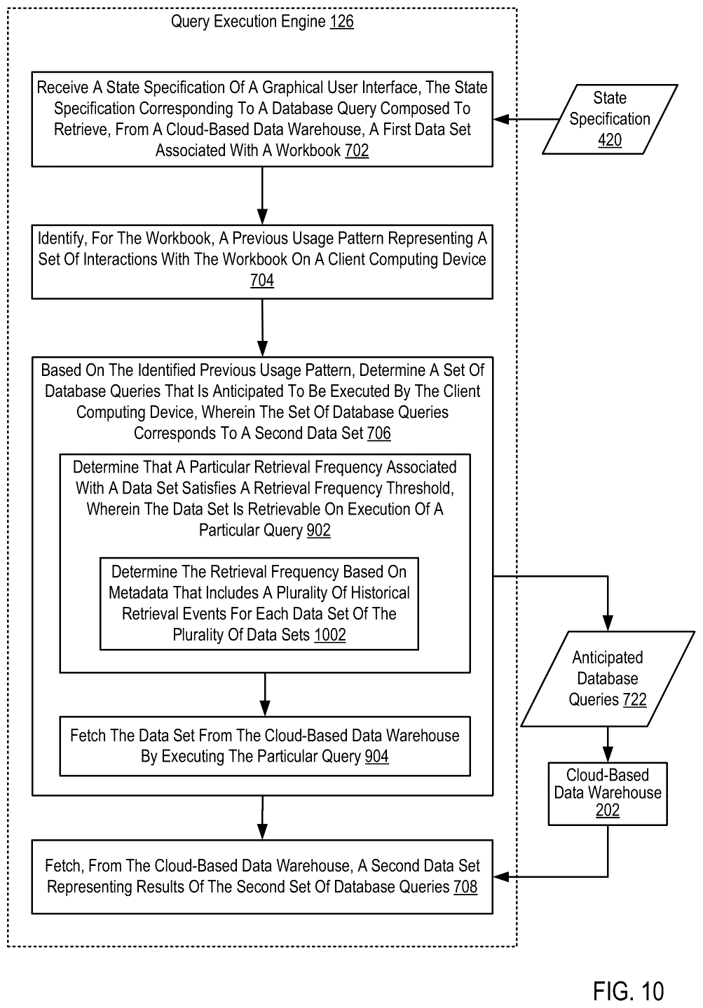

For further explanation, FIG. 10 sets forth a flow chart illustrating a further exemplary method for fetching ideal data sets based on usage patterns according to embodiments of the present invention. The method of FIG. 10 is similar to the method of FIG. 7 in that the method of FIG. 10 also includes receiving 702 a state specification of a graphical user interface, the state specification corresponding to a database query composed to retrieve, from a cloud-based data warehouse, a first data set associated with a workbook; identifying 704, for the workbook, a previous usage pattern representing a set of interactions with the workbook on a client computing device, wherein the previous usage pattern includes the database query; determining 706, based on the identified previous usage pattern, a set of database queries that is anticipated to be executed by the client computing device, wherein the set of database queries corresponds to a second data set; and fetching 708, from the cloud-based data warehouse, one or more execution results that include the first data set and the second data set.

The method of FIG. 10 differs from the method of FIG. 7, however, in that the method of FIG. 10 includes determining 1002 a retrieval frequency from the metadata of the data set based on a plurality of historical retrieval events for each data set of the plurality of data sets, where each data set of a plurality of data sets retrievable from the cloud-based data warehouse is associated with a retrieval frequency. Determining 1002 the retrieval frequency based on a plurality of historical retrieval events for each data set of the plurality of data sets may be carried out by evaluating a query execution history associated with a particular workbook and determining a frequency, over a period of time, with which particular data sets are retrieved from the cloud-based data warehouse 192. For example, for a particular workbook, a data set may be retrieved 90% of the time the workbook is opened. As described above with respect to FIG. 9, if a particular data set is observed as being retrieved at a retrieval frequency that satisfies a retrieval frequency threshold, the database query used to retrieve that data set may be considered an anticipated query that is anticipated to be executed as part of a usage pattern associated with the workbook. Accordingly, if the retrieval frequency, based on a plurality of historical retrieval events, satisfies the retrieval frequency threshold, then the anticipated query may be automatically executed to retrieve the data set.

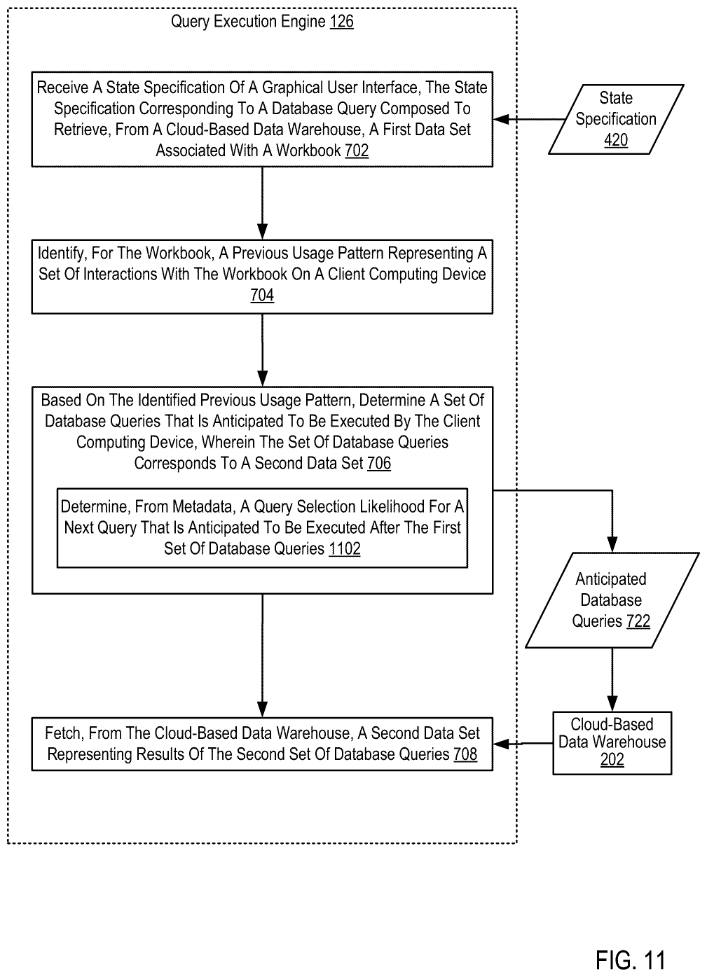

For further explanation, FIG. 11 sets forth a flow chart illustrating a further exemplary method for fetching ideal data sets based on usage patterns according to embodiments of the present invention. The method of FIG. 11 is similar to the method of FIG. 7 in that the method of FIG. 11 also includes receiving 702 a state specification of a graphical user interface, the state specification corresponding to a database query composed to retrieve, from a cloud-based data warehouse, a first data set associated with a workbook; identifying 704, for the workbook, a previous usage pattern representing a set of interactions with the workbook on a client computing device, wherein the previous usage pattern includes the database query; determining 706, based on the identified previous usage pattern, a set of database queries that is anticipated to be executed by the client computing device, wherein the set of database queries corresponds to a second data set; and fetching 708, from the cloud-based data warehouse, one or more execution results that include the first data set and the second data set.

The method of FIG. 11 differs from the method of FIG. 7, however, in that determining 706, based on the identified previous usage pattern, a set of database queries that is anticipated to be executed by the client computing device, wherein the set of database queries corresponds to a second data set includes determining 1102 a query selection likelihood from the metadata of the data set for a next query that is anticipated to be executed after the database query. Determining 1102 a query selection likelihood for a next query that is anticipated to be executed after the database query can be carried out by identifying a usage pattern or behavior pattern associated with a workbook, a workbook element, an organization, a user that has used the workbook, an application associated with the workbook, or the like. For example, the next query and the (first) database query may be part of a query execution schema (e.g., a Salesforce schema or other ERP-related schema). It may be determined that a next query is anticipated to be executed in a sequence after the first database query. As another example, it may be determined that after a user 1 executes query 1, user 2 executes query 2 90% of the time. Then the query selection likelihood for the next query may be determined to be 90% for query 2.

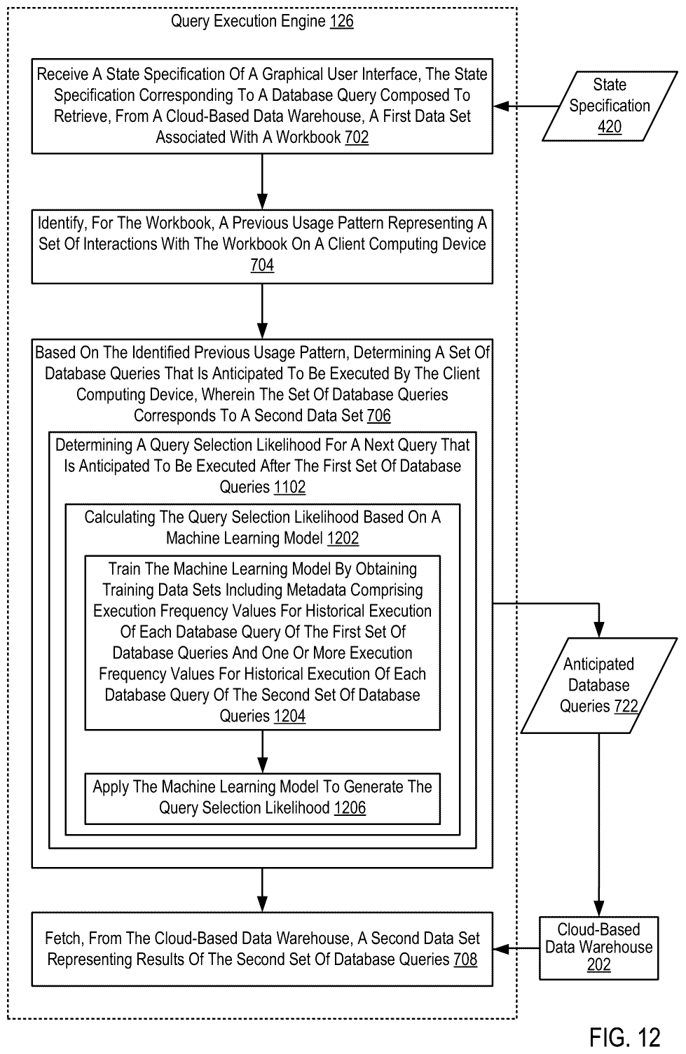

For further explanation, FIG. 12 sets forth a flow chart illustrating a further exemplary method for fetching ideal data sets based on usage patterns according to embodiments of the present invention. The method of FIG. 8 is similar to the method of FIG. 7 in that the method of FIG. 12 also includes receiving 702 a state specification of a graphical user interface, the state specification corresponding to a database query composed to retrieve, from a cloud-based data warehouse, a first data set associated with a workbook; identifying 704, for the workbook, a previous usage pattern representing a set of interactions with the workbook on a client computing device, wherein the previous usage pattern includes the database query; determining 706, based on the identified previous usage pattern, a set of database queries that is anticipated to be executed by the client computing device, wherein the set of database queries corresponds to a second data set; and fetching 708, from the cloud-based data warehouse, one or more execution results that include the first data set and the second data set.

The method of FIG. 12 differs from the method of FIG. 7, however, in that the method of FIG. 12 also includes calculating 1202 the query selection likelihood based on a machine learning model. A machine learning system may be configured to ingest data pertaining to query executions, data set retrievals, workbook usage patterns, and other data, and output results obtained from processing the inputted data using one or more machine learning models. In some implementations, query execution engine 126 may implement various machine learning models such as linear regression models, random forest classifier models, and the like. The implemented machine learning models may be configured to output query execution likelihoods indicating the extent to which a particular query is likely to be executed after a first database query. A machine learning model may be trained using query execution history data for the first database query and any other database queries. The data may be historical query execution data obtained from, for example, previous interactions with the workbook that included execution of the first database query.

The method of FIG. 12 also includes training 1204 the machine learning model to calculate the query selection likelihood. The machine learning model may be trained over time using training data sets that use metadata of a data set and/or data of the data set. The metadata may include execution frequency values for the first database query and other database queries associated with the workbook. Moreover, as described above, the method of FIG. 12 also includes applying 1206 the machine learning model to generate the query selection likelihood for a particular query. For example, given a first database query, the machine learning model may output a likelihood of 90% that a second database query is likely to be executed next by a user. In view of this query execution likelihood, query execution engine 126 may determine that the second database query is an anticipated database query and automatically execute it to obtain execution results for the anticipated database query in addition to execution results for the first database query.

In view of the explanations set forth above, readers will recognize that the benefits of prefetching query results using expanded queries according to embodiments of the present invention include:
Improving the operation of a computing system by retrieving additional anticipated data sets thereby alleviating the need for subsequent calls to the cloud-base data. This is accomplished by anticipating subsequently requested data sets based on prior usage of the workbook.

Exemplary embodiments of the present invention are described largely in the context of a fully functional computer system for prefetching query results using expanded queries. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for fetching ideal data sets based on usage patterns, the method comprising:
receiving a state specification of a graphical user interface, the state specification corresponding to a database query composed to retrieve, from a cloud-based data warehouse, a first data set associated with a workbook;
identifying, for the workbook, a previous usage pattern representing a set of interactions with the workbook on a client computing device, wherein the previous usage pattern includes the database query;
based on the identified previous usage pattern, determining a set of database queries that is anticipated to be executed by the client computing device, wherein the set of database queries corresponds to a second data set; and
fetching, from the cloud-based data warehouse, one or more execution results that include the first data set and the second data set.

2. The method of claim 1 wherein the database query is related to the set of database queries.

3. The method of claim 1, wherein determining the set of database queries that is anticipated to be executed further comprises:
identifying the previous usage pattern based on the database query, wherein a run time of the database query is prior to a current time.

4. The method of claim 1, wherein metadata for each data set of a plurality of data sets retrievable from the cloud-based data warehouse includes a retrieval frequency, and wherein the method further comprises:
determining that a particular retrieval frequency associated with a data set satisfies a retrieval frequency threshold, wherein the data set is retrievable on execution of a particular query; and
fetching the data set from the cloud-based data warehouse by executing the particular query.

5. The method of claim 4, further comprising determining the retrieval frequency based on metadata that includes a plurality of historical retrieval events for each data set of the plurality of data sets.

6. The method of claim 1, wherein determining the set of database queries that is anticipated to be executed further comprises determining, from metadata of the first data set, a query selection likelihood for a next query that is anticipated to be executed after the database query.

7. The method of claim 6, further comprising calculating the query selection likelihood based on a machine learning model.

8. The method of claim 7, further comprising:
training the machine learning model to calculate the query selection likelihood, the training comprising:
obtaining training data sets that include metadata for each data set, each training data set of historical data comprising:
one or more execution frequency values for historical execution of each database query of the database query; and
one or more execution frequency values for historical execution of each database query of the set of database queries;
training the machine learning model based on the training data sets; and
applying the machine learning model to generate the query selection likelihood.

9. An apparatus for fetching ideal data sets based on usage patterns, the apparatus comprising a computer processor, a computer memory operatively coupled to the computer processor, the computer memory having disposed within it computer program instructions that, when executed by the computer processor, cause the apparatus to carry out the steps of:
receiving a state specification of a graphical user interface, the state specification corresponding to a database query composed to retrieve, from a cloud-based data warehouse, a first data set associated with a workbook;
identifying, for the workbook, a previous usage pattern representing a set of interactions with the workbook on a client computing device, wherein the previous usage pattern includes the database query;
based on the identified previous usage pattern, determining a set of database queries that is anticipated to be executed by the client computing device, wherein the set of database queries corresponds to a second data set; and
fetching, from the cloud-based data warehouse, one or more execution results that include the first data set and the second data set.

10. The apparatus of claim 9, wherein the computer program instructions for determining the set of database queries that is anticipated to be executed further cause the apparatus to carry out the step of:
identifying the previous usage pattern based on the database query, wherein a run time of the database query is prior to a current time.

11. The apparatus of claim 9, wherein metadata for each data set of a plurality of data sets retrievable from the cloud-based data warehouse includes a retrieval frequency, and wherein the computer program instructions further cause the apparatus to carry out the step of:
determining that a particular retrieval frequency associated with a data set satisfies a retrieval frequency threshold, wherein the data set is retrievable on execution of a particular query; and
fetching the data set from the cloud-based data warehouse by executing the particular query.

12. The apparatus of claim 11, wherein the computer program instructions further cause the apparatus to carry out the step of:
determining the retrieval frequency based on metadata that includes a plurality of historical retrieval events for each data set of the plurality of data sets.

13. The apparatus of claim 9, wherein the computer program instructions further cause the apparatus to carry out the step of:
determining, from metadata of the first data set, a query selection likelihood for a next query that is anticipated to be executed after the database query.

14. The apparatus of claim 13, wherein the computer program instructions further cause the apparatus to carry out the step of:
calculating the query selection likelihood based on a machine learning model.

15. A computer program product for fetching ideal data sets based on usage patterns, the computer program product disposed upon a computer readable medium, the computer program product comprising computer program instructions that, when executed, cause a computer to carry out the steps of:
receiving a state specification of a graphical user interface, the state specification corresponding to a database query composed to retrieve, from a cloud-based data warehouse, a first data set associated with a workbook;
identifying, for the workbook, a previous usage pattern representing a set of interactions with the workbook on a client computing device, wherein the previous usage pattern includes the database query;
based on the identified previous usage pattern, determining a set of database queries that is anticipated to be executed by the client computing device, wherein the set of database queries corresponds to a second data set; and
fetching, from the cloud-based data warehouse, one or more execution results that include the first data set and the second data set.

16. The computer program product of claim 15, wherein the computer program instructions further cause the computer to carry out the step of:
identifying the previous usage pattern based on the database query, wherein a run time of the database query is prior to a current time.

17. The computer program product of claim 15, wherein metadata for each data set of a plurality of data sets retrievable from the cloud-based data warehouse includes a retrieval frequency, wherein the computer program instructions further cause the computer to carry out the steps of:
determining that a particular retrieval frequency associated with a data set satisfies a retrieval frequency threshold, wherein the data set is retrievable on execution of a particular query; and
fetching the data set from the cloud-based data warehouse by executing the particular query.

18. The computer program product of claim 17, wherein the computer program instructions further cause the computer to carry out the steps of:
determining the retrieval frequency from the metadata based on a plurality of historical retrieval events for each data set of the plurality of data sets.

19. The computer program product of claim 15, wherein the computer program instructions further cause the computer to carry out the steps of:
determining, from metadata of the first data set, a query selection likelihood for a next query that is anticipated to be executed after the database query.

20. The computer program product of claim 19, wherein the computer program instructions further cause the computer to carry out the step of calculating the query selection likelihood based on a machine learning model.
